(19) United States
(12) Patent Application Publication
(10) Pub. No.: US 2021/0404507 A1
(43) Pub. Date: Dec. 30, 2021

(54) NONREVERSIBLE ANTI-BACKLASH NUT

(71) Applicant: Shanghai Moons' Electric Co., LTD., Shanghai (CN)

(72) Inventors: Kai ZENG, Shanghai (CN); Zhigan WU, Shanghai (CN); Wufeng YUAN, Shanghai (CN); Yiming ZOU, Shanghai (CN); Guangyu LIU, Shanghai (CN)

(21) Appl. No.: 16/478,112

(22) PCT Filed: Sep. 14, 2018
(86) PCT No.: PCT/CN2018/105602

§ 371 Date: Jul. 15, 2019

(30) Foreign Application Priority Data
May 22, 2018 (CN) 201810495219.1

(51) Int. Cl. F16B 39/12; F16H 25/20; F16H 25/24

(52) U.S. Cl. CPC F16B 39/122; F16H 25/24; F16H 25/2009; F16B 39/126

(57) ABSTRACT

A nonreversible anti-backlash nut comprises a first nut body and a second nut which are provided with internal threads, and a shrinkage ring which is capable of shrinking inwards in a radial direction and is disposed between the first nut body and the second nut body. Nut body chamfers are separately arranged on sides, connected with the shrinkage ring, of the first nut body and the second nut body. A shrinkage ring chamfer is arranged at a position, corresponding to the nut body chamfers, of the shrinkage ring. After the nut is assembled, the shrinkage ring provides a shrinkage force to push, via the chamfers, the first nut body and the second nut body away from each other, so that an axial clearance of the nut is eliminated. Compared with the prior art, the nut has a better and more uniform clearance elimination effect.

### TECHNICAL FIELD

The invention relates to a nut, in particular to a nonreversible anti-backlash nut.

### DESCRIPTION OF RELATED ART

Micro lead screws and micro nuts have been widely used in the motion control field. Due to the fact that nuts may become worn after being used for a period of time and that a clearance generated after the nuts are worn will result in positional errors when the motion direction of the nuts is changed, the primary aspect that should be taken into consideration for improving the precision of screw pairs is how to eliminate these motion errors.

According to existing techniques, a spring through which two nuts having identical leads are connected in the axial direction (for instance, Chinese Utility Model Patent Publication No. CN201003581Y) is used to provide an axial pushing or pulling force for the nuts to overcome a load and to eliminate a clearance. However, such a solution has the drawback that when the nuts bear a large load, a reactive force will be applied to the axial spring and an anti-backlash system moves reversely, which in turn increase the errors.

### BRIEF SUMMARY OF THE INVENTION

The objective of the invention is to overcome the drawbacks of the prior art by providing a nonreversible anti-backlash nut.

The following technical solution is adopted by the invention to fulfill the above objective.

A nonreversible anti-backlash nut comprises a first nut body, a second nut body and a shrinkage ring, wherein the first nut body and the second nut body are provided with internal threads, and the shrinkage ring is capable of shrinking inwards in a radial direction and is disposed between the first nut body and the second nut body; nut body chamfers are separately arranged on sides, connected with the shrinkage ring, of the first nut body and the second nut body; and a shrinkage ring chamfer is arranged at a position, corresponding to the nut body chamfers, of the shrinkage ring.

After the nut is assembled, the shrinkage ring provides a shrinkage force to push, via the chamfers, the first nut body and the second nut body away from each other, so that an axial clearance of the nut is eliminated.

Preferably, an angle difference between the nut body chamfers and the shrinkage ring chamfer is smaller than 9.8°.

Preferably, the shrinkage ring chamfer has an angle of 6.8°-47.8°.

Preferably, the shrinkage ring chamfer has an angle of 12°-28.2°.

Preferably, the shrinkage ring is a coil spring, a loop, an O-shaped ring or other elastic structures capable elastically shrinking inwards.

Preferably, the shrinkage ring is open or is not open.

Preferably, when the shrinkage ring is open, the length of the shrinkage ring is over or less than 50% of the full circumference of the shrinkage ring.

Preferably, the shrinkage ring is a funnel-shaped cone.

Preferably, the shrinkage ring comprises an outer ring and an inner ring, wherein the shrinkage ring chamfer is arranged on the inner ring, the outer ring squeezes the inner ring from the outer side, and the inner ring provides a shrinkage force to push, via the chamfers, the first nut body and the second nut body away from each other, so that an axial clearance of the nut is eliminated.

Preferably, the inner ring is open or is not open.

Preferably, when the inner ring is open, the length of the inner ring is over or less than 50% of the full circumference of the inner ring.

Preferably, the inner ring is a funnel-shaped cone.

Preferably, one, two or more inner rings are included.

Preferably, the shrinkage ring chamfer on a side face of the inner ring has an angle of 6.8°-45.2°.

Preferably, the shrinkage ring chamfer on the side face of the inner ring has an angle of 9.8°-25.5°.

Compared with the prior art, the invention has the following advantages:

1) The chamfer angle can be freely adjusted to fulfill nonreversible clearance elimination when the nut is made from different materials, as shown in FIG. 9, so that the nut has constant performance even if made from different materials.

2) Based on the nonreversible clearance elimination principle, the nut can bear a load over 50N without generating an obvious clearance, so that system precision is hardly affected; and compared with a nut of a spring structure, the nut has great advantages, as shown in FIG. 10.

3) Existing anti-backlash nuts have multiple components (usually more than five components), while the nut in this patent can fulfill the same effect with only three components, so that the system quality risk is drastically reduced.

4) The shrinkage ring can apply a uniform pressure to the full circumferential surface of the nut and has a standard pressure distribution deviation smaller than 20N, so that good uniformity is realized for the anti-backlash nut, and a better and more uniform clearance elimination effect is achieved, as shown in FIG. 11.

### BRIEF DESCRIPTION OF THE SEVERAL VIEWS OF THE DRAWINGS

FIG. 1 is a structural view of embodiment 1, wherein 1 refers to first nut body, 2 refers to shrinkage ring, and 3 refers to second nut body;

FIG. 2 is a sectional view of embodiment 1, wherein 4 refers to shrinkage ring chamfer, and 5 refers to nut body chamfer;

FIG. 3 is a structural view of a shrinkage ring of embodiment 1;

FIG. 4 is a structural view of embodiment 2, wherein 1 refers to first nut body, 21 refers to outer ring, 22 refers to inner ring, and 3 refers to second nut body;

FIG. 5 is an assembled view of embodiment 2;

FIG. 6 is a schematic diagram of the inclination angle of a side face of the shrinkage ring or the inner ring;

FIG. 7 is a structural view of a chamfer on a side face of the nut body;

FIG. 8 is an enlarged view of part A in FIG. 7;

FIG. 9 is a schematic diagram of a chamfer of the inner ring when the nut body is made from different materials;

FIG. 10 is a performance comparison diagram of the invention and the prior art under a heavy load;

FIG. 11 is a schematic diagram of a circumferential pressure uniformly applied to the whole circumference of a C-shaped shrinkage ring.

### DETAILED DESCRIPTION OF THE INVENTION

Technical solutions of the embodiments of the invention are clearly and completely explained below in combination with the accompanying drawings. Apparently, the embodiments in the following description are only certain illustrative ones and not all possible ones of the invention. All other embodiments obtained by those ordinarily skilled in this field based on these illustrative ones without creative work should also fall within the protection scope of the invention.

### Embodiment 1

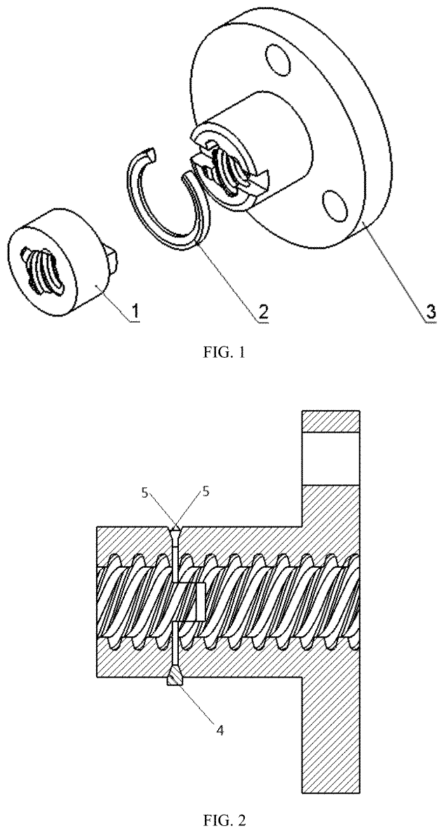

As shown in FIGS. 1-3, a nonreversible anti-backlash nut comprises a first nut body 1, a second nut body 3 and a shrinkage ring 2, wherein the first nut body 1 and the second nut body 3 are provided with internal threads, and the shrinkage ring 2 is capable of shrinking inwards in a radial direction and is disposed between the first nut body 1 and the second nut body 3; nut body chamfers 5 are separately arranged on sides, connected with the shrinkage ring 2, of the first nut body 1 and the second nut body 3; and a shrinkage ring chamfer 4 is arranged at a position, corresponding to the nut body chamfers 5, of the shrinkage ring 2.

After the nut is assembled, the shrinkage ring 2 provides a shrinkage force to push, via the chamfers, the first nut body 1 and the second nut body 3 away from each other, so that an axial clearance of the nut is eliminated.

An angle difference between the nut body chamfers 5 and the shrinkage ring chamfer 4 is smaller than 9.8°.

The shrinkage ring chamfer has an angle Θ1 of 6.8°-47.8°. Preferably, the shrinkage ring chamfer has an angle Θ1 of 12°-28.2°

The shrinkage ring is a coil spring, a loop, an O-shaped ring or other elastic structures capable of elastically shrinking inwards.

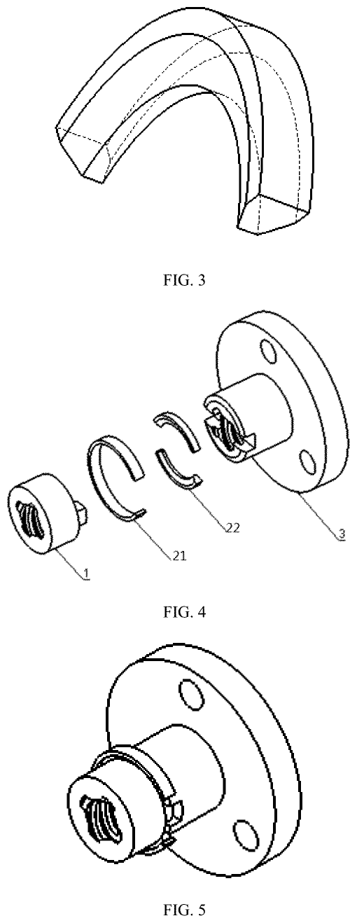

The shrinkage ring is open or is not open. When the shrinkage ring is open, the length of the shrinkage ring is over or less than 50% of the full circumference of the shrinkage ring, as shown in FIG. 3. The shrinkage ring can even be a funnel-shaped cone.

### Embodiment 2

As shown in FIGS. 4 and 5, the shrinkage ring comprises an outer ring 21 and an inner ring 22. The shrinkage ring chamfer 4 is arranged on the inner ring 22. The outer ring 21 squeezes the inner ring 22 from the outside, and the inner ring 22 provides a shrinkage force to push, via the chamfers, the first nut boy 1 and the second nut body 3 away from each other, so that an axial clearance of the nut is eliminated.

The inner ring is open or is not open.

When the inner ring is open, the inner ring can be long or short, can be a small section on the circumference or can even be a funnel-shaped cone, and the length of the inner ring is over or less than 50% of the full circumference of the inner ring.

One, two or more inner rings are included.

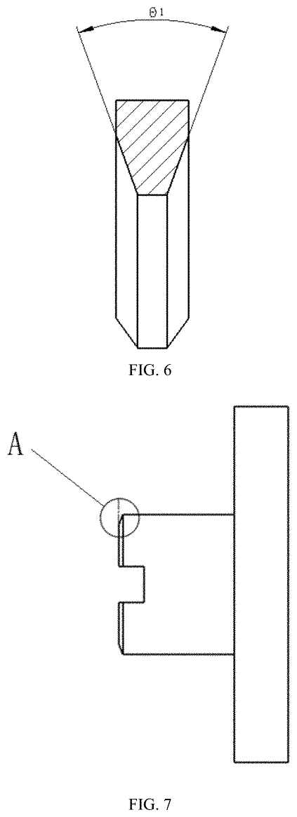

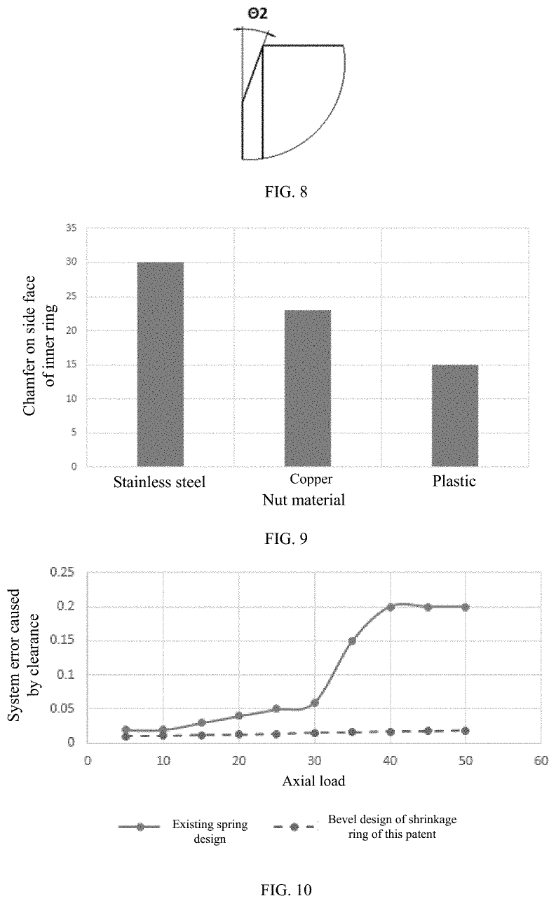

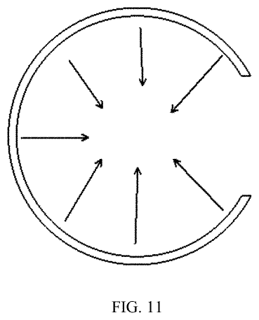

As shown in FIG. 6, the shrinkage ring chamfer on a side face of the inner ring has an angle Θ1 of 6.8°-45.2°. Preferably, the shrinkage ring chamfer on the side face of the inner ring has an angle Θ1 of 9.8°-25.5°.

As shown in FIG. 7 and FIG. 8, the nut body chamfers have an angle Θ2 not greater than 285°*μ, and the first nut body is highly matched with the second nut body, wherein μ refers to the friction coefficient of a matching surface between the inner ring (or the shrinkage ring) and the first nut body or between the inner ring (or the shrinkage ring) and the second nut body. Preferably, the angle Θ2 of the nut body chamfers is 65°*μ≤Θ2≤135°*μ.

The above embodiments are only specific ones of the invention and are not intended to limit the protection scope of the invention. Various equivalent modifications or substitutes easily achieved by those skilled in this technical field based on the technical contents of the invention should also fall within the protection scope of the invention. Therefore, the protection scope of the invention is subject to the protection scope defined by the claims.

1. A nonreversible anti-backlash nut, comprising a first nut body and a second nut which are provided with internal threads, wherein the nut further comprises a shrinkage ring which is capable of shrinking inwards in a radial direction and is disposed between the first nut body and the second nut body; nut body chamfers are separately arranged on sides, connected with the shrinkage ring, of the first nut body and the second nut body; and a shrinkage ring chamfer is arranged at a position, corresponding to the nut body chamfers, of the shrinkage ring;
after the nut is assembled, the shrinkage ring provides a shrinkage force to push, via the chamfers, the first nut body and the second nut body away from each other, so that an axial clearance of the nut is eliminated.

2. The nut according to claim 1, wherein an angle difference between the nut body chamfers and the shrinkage ring chamfer is smaller than 9.8°.

3. The nut according to claim 1, wherein the shrinkage ring chamfer has an angle of 6.8°-47.8°.

4. The nut according to claim 3, wherein the angle of the shrinkage ring chamfer is 12°-28.2°.

5. The nut according to claim 1, wherein the shrinkage ring is a coil spring, a loop, an O-shaped ring or other elastic structures capable elastically shrinking inwards.

6. The nut according to claim 1, wherein the shrinkage ring is open or is not open.

7. The nut according to claim 6, wherein when the shrinkage ring is open, a length of the shrinkage ring is over or less than 50% of a full circumference of the shrinkage ring.

8. The nut according to claim 6, wherein the shrinkage ring is a funnel-shaped cone.

9. The nut according to claim 1, wherein the shrinkage ring comprises an outer ring and an inner ring, the shrinkage ring chamfer is arranged on the inner ring, the outer ring squeezes the inner ring from the outside, and the inner ring provides a shrinkage force to push, via the chamfers, the first nut body and the second nut body away from each other, so that an axial clearance of the nut is eliminated.

10. The nut according to claim 9, wherein the inner ring is open or is not open.

11. The nut according to claim 10, when the inner ring is open, a length of the inner ring is over or less than 50% of a full circumference of the inner ring.

12. The nut according to claim 10, wherein the inner ring is a funnel-shaped cone.

13. The nut according to claim 9, wherein one, two or more said inner rings are included.

14. The nut according to claim 9, wherein the shrinkage ring chamfer on a side face of the inner ring has an angle of 6.8°-45.2°.

15. The nut according to claim 14, wherein the angle of the shrinkage ring chamfer on the side face of the inner ring is 9.8°-25.5°.
